(19) United States
(12) Patent Application Publication
(10) Pub. No.: US 2026/0322852 A1
(43) Pub. Date: Oct. 15, 2026

(54) CLOUD SERVICE THREAT ANALYSIS DEVICE, CLOUD SERVICE THREAT ANALYSIS METHOD, AND CLOUD SERVICE THREAT ANALYSIS PROGRAM

(71) Applicant: OMRON CORPORATION, Kyoto-shi (JP)

(72) Inventor: Eikichi MAKITANI, Muko-shi (JP)

(73) Assignee: OMRON CORPORATION, Kyoto-shi (JP)

(21) Appl. No.: 19/643,158

(22) Filed: Apr. 9, 2026

(30) Foreign Application Priority Data
Apr. 11, 2025 (JP) 2025-065665

(51) Int. Cl. H04L 9/40

(52) U.S. Cl. CPC H04L 63/1458; H04L 63/1483

(57) ABSTRACT

It is an object of the present invention to accurately analyze a target system 1 that uses cloud service, and provide guidelines for addressing the risks identified through this analysis. With a threat analysis device (10), information about services included in the target system (1) is extracted on the basis of information acquired from the target system (1). For each extracted service, potential attack methods are assigned, and the risk level of the attack methods for each service are estimated for each combination of service and attack method. Furthermore, the required level of defense against attack methods for the service is evaluated on the basis of the estimated risk level. Consequently, it is possible to comprehensively and accurately analyze risks and evaluate the level of defense required for the services that make up the target system (1). Accordingly, it is possible to accurately analyze risks and provide guidelines for addressing the risks identified through this analysis.

### CROSS-REFERENCE TO RELATED APPLICATIONS

This application claims priority to Japanese Patent Application No. 2025-065665 filed on Apr. 11, 2025. The entire disclosure of Japanese Patent Application No. 2025-065665 is hereby incorporated herein by reference.

### TECHNICAL FIELD

The present invention relates to a cloud service threat analysis device, a cloud service threat analysis method, and a cloud service threat analysis program, with which risks that pose threats to systems that use cloud services are analyzed.

### BACKGROUND ART

Threat analysis methods and threat analysis systems have been created in the past to ascertain and deal with security risks posed to various systems and devices.

Conventional systems and devices that have existed for some time consist of various kinds of hardware component, and each hardware component processes and otherwise manages assets and distributes them among elements according to its assigned function. Conventional threat analysis methods and threat analysis systems are considered to analyze such conventional systems and devices.

For example, Patent Literature 1 discloses an analysis method in which attacks on assets are analyzed by using the flow of assets (logical data flow) for functions, in addition to the flow of assets (physical data flow) for hardware components. According to Patent Literature 1, analysis involving both physical data flow and logical data flow makes it possible to ascertain the threat of intrusion from a logical session against attacks originating in the download of unauthorized third-party apps, and also allows security risks to be accurately analyzed.

In recent years, in addition to the above-mentioned conventional systems and devices, cloud services have come into use in which users are provided with services such as servers, storage, and software via the Internet, allowing them to use only what they need, when they need it. There is also a need to ascertain and address the risks posed to systems that make use of these cloud services.

### CITATION LIST

### Patent Literature

Patent Literature 1: JP-A 2023-047569

### DISCLOSURE OF INVENTION

### Technical Problem

However, as mentioned above, in the threat analysis method of Patent Literature 1, analysis is performed using the flow of assets to hardware components and the flow of assets to functions assigned to the hardware components, and with this method, the analysis target is considered to be conventional systems and devices. Therefore, the threat analysis method of Patent Document 1 is unlikely to accurately analyze the risks of systems that use cloud services.

Furthermore, the threat analysis method of Patent Literature 1 only analyzes risk. Therefore, it does not tell us how to deal with a risk that has been identified. On the other hand, users of cloud services use services only when and as needed, so it is anticipated that the damage caused by threats will tend to be greater. Accordingly, threat analysis methods in which the analysis target is cloud services need not only to accurately analyze risks, but also to provide guidelines for suitable measures to deal with risks.

It is an object of the present invention to provide a cloud service threat analysis device, a cloud service threat analysis method, and a cloud service threat analysis program with which risks can be accurately analyzed in systems that use cloud services, and guidelines are provided for dealing with the risks identified by this analysis.

### Technical Solution

The cloud service threat analysis device according to the first invention includes an information acquisition unit, a service information extraction unit, an analysis unit, and an evaluation unit, which will be described below.

First, the information acquisition unit acquires information from an analysis target, where the analysis target is a system that uses a cloud service. The service information extraction unit then extracts information about the services had by the analysis target, on the basis of the information acquired by the information acquisition unit. Also, the analysis unit identifies possible attack methods for each service extracted by the service information extraction unit, and estimates the risk level of the attack methods in the services for each combination of service and attack method. Furthermore, the evaluation unit evaluates the required level of defense against the attack methods for the services, on the basis of the risk level estimated by the analysis unit.

Consequently, the risk level of the attack methods for each service can be estimated for all of the combinations of the individual services included in the system being analyzed and the attack methods that could be used against each service. Accordingly, the risk posing a threat to the system being analyzed can be accurately analyzed. Furthermore, the required level of defense against the attack methods for each service can be evaluated for each combination, which means that guidelines can be provided for dealing with the risks identified by this analysis.

This means that it is possible to comprehensively and accurately analyze the risks and evaluate the required level of defense for all of the services that make up the system being analyzed. As a result, the risks of systems that use cloud services can be accurately analyzed, and guidelines can then be provided for dealing with the risks identified by this analysis.

The cloud service threat analysis device according to the second invention is the cloud service threat analysis device according to the first invention, wherein the analysis unit estimates an individual risk level by individually weighting each risk assessment category, and estimates a risk level for each combination on the basis of the sum of all the weighted individual risk levels.

This allows weighting of each risk assessment category and estimation of the individual risk level, which means that risk can be analyzed more accurately. Therefore, more reliable guidelines can be provided.

The cloud service threat analysis device according to the third invention is the cloud service threat analysis device according to the first invention, wherein the types of attack method include spoofing, tampering, repudiation, information leakage, denial of service, and privilege elevation.

Consequently, all of the attack methods, taking into account the thoughts and behavior patterns of the person making a threat, that is, the attacker, can be considered, and the types of attack method can be comprehensively reflected in the estimate. Accordingly, risk levels can be estimated in a more precisely, and more reliable guidelines can be provided.

The cloud service threat analysis device according to the fourth invention is the cloud service threat analysis device according to the second invention, wherein the risk assessment categories include possibility of damage, reproducibility, exploitability, affected users, and discoverability.

Consequently, all of the risk assessment categories can be considered, and the risk assessment categories can be comprehensively reflect them in the estimate. Accordingly, risk levels can be estimated in a more precisely, and more reliable guidelines can be provided.

The cloud service threat analysis device according to the fifth invention is the cloud service threat analysis device according to the second invention, wherein the service information extraction unit extracts first resource information that indicates whether the resource of the service is singular or plural, and second resource information that indicates whether the resource is included in different networks if the resource is plural. The analysis unit weights the individual risk levels by referring to the first and second resource information.

Consequently, the actual state of the service can be reflected in the risk level, making it possible to estimate a risk level that more accurately reflects reality.

The cloud service threat analysis device according to the sixth invention is the cloud service threat analysis device according to the first invention, wherein the information acquisition unit acquires meta-information had by the analysis target through an application programming interface (API). The service information extraction unit extracts information related to services provided by the analysis target, on the basis of the meta-information acquired by the information acquisition unit.

This allows the content of the services and block configuration of the analysis target to be accurately ascertained, and this reduces the likelihood of performing analysis using inaccurate information.

The cloud service threat analysis device according to the seventh invention is the cloud service threat analysis device according to the second invention, wherein the analysis unit estimates a risk level for each combination of the service and the attack method on the basis of a score table that gives scores set for each combination of the service type, the attack method type, and the risk assessment categories, as data indicating the individual risk level.

Consequently, scores set for each combination of service type, attack method type, and risk assessment category can be placed in a score table in advance as data indicating individual risk levels, which makes it simple to estimate risk levels. Accordingly, estimating risk levels is less of a burden.

The cloud service threat analysis device according to the eighth invention is the cloud service threat analysis device according to the seventh invention, wherein the service information extraction unit extracts first resource information that indicates whether the resource of the service is singular or plural, and second resource information that indicates whether the resource is included in different networks if the resource is plural.

The analysis unit then sets a reference score different from the score in the score table according to the first and second resource information, and if a comparison of the score in the score table with the reference score indicates that the reference score is more heavily weighted, the score in the score table is replaced with the reference score, and a risk level is estimated for each combination of the service and the attack method.

This makes it easy for the actual state of the service to be reflected in the risk level by setting a reference score that indicates the actual state of the service and comparing it with the score in the score table. Accordingly, risk levels that more closely reflect reality can be easily estimated.

The cloud service threat analysis device according to the ninth invention is the cloud service threat analysis device according to the first invention, wherein the analysis unit associates each of the services extracted by the service information extraction unit with one of the constituent elements of a data flow diagram (DFD), and when assigning a possible attack method, assigns an attack method specific to the associated element.

This allows types of attack that are unlikely to occur to be excluded from the risk level estimation calculation. In other words, because the types of attack that are likely to occur can be ascertained for each element from the nature of the DFD constituent elements, by assigning specific attack methods to the elements linked to the extracted services, it is possible to exclude types of attack that are unlikely to occur from the estimation calculation. This reduces the burden of estimation calculation and allows risk levels to be estimated more accurately.

The cloud service threat analysis method according to the tenth invention comprises an information acquisition step, a service information extraction step, an analysis step, and an evaluation step, which are described below.

First, in the information acquisition step, information is acquired from a system that uses a cloud service as the analysis target. Next, in the service information extraction step, information about the services that the analysis target has is extracted on the basis of the information acquired in the information acquisition step. In the analysis step, possible attack methods are identified for each service extracted in the service information extraction step and the risk levels of the attack methods are estimated for the service for each combination of service and attack method. In the evaluation step, the required level of defense against the attack methods is evaluated for the service according to the risk level estimated in the analysis step.

Consequently, the risk level of the attack methods can be estimated for each service for all combinations of the individual services included in the system being analyzed and the attack methods that could be used on each service. Accordingly, risks posing a threat to the system being analyzed can be accurately analyzed. Furthermore, since the required level of defense against the attack methods used in the service can be evaluated for each combination, it is possible to provide guidelines for addressing the risks identified by this analysis.

This makes it possible to comprehensively and accurately analyze the risks and evaluate the required level of defense for all of the services that make up the system being analyzed. As a result, the risks of systems that use cloud services can be accurately analyzed, and guidelines for dealing with the risks identified by this analysis can be provided.

The cloud service threat analysis program according to the eleventh invention is a program that causes a computer to execute a cloud service threat analysis method that includes an information acquisition step, a service information extraction step, an analysis step, and an evaluation step, which will be described below.

First, in the information acquisition step, information is acquired from a system that uses a cloud service as the analysis target. Next, in the service information extraction step, information about the services that the analysis target has is extracted on the basis of the information acquired in the information acquisition step. In the analysis step, possible attack methods are identified for each service extracted in the service information extraction step and the risk levels of the attack methods are estimated for the service for each combination of service and attack method. In the evaluation step, the required level of defense against the attack methods is evaluated for the service according to the risk level estimated in the analysis step.

Consequently, the risk level of attack methods in a service can be estimated for all combinations of the individual services included in the system being analyzed and the attack methods that could be used on each individual service. Accordingly, risks posing a threat to the system being analyzed can be accurately analyzed. Furthermore, since the required level of defense against the attack methods in a service can be evaluated for each combination, it is possible to provide guidelines for addressing the risks identified by this analysis.

This means that the risks can be comprehensively and accurately analyzed and the required level of defense evaluated for all of the services that make up the system being analyzed. As a result, the risks to a system that uses cloud services can be accurately analyzed, and then guidelines can be provided for dealing with the risks identified by this analysis.

### ADVANTAGEOUS EFFECTS

With the cloud service threat analysis device according to the present invention, risks to a system that uses cloud services can be accurately analyzed, and then guidelines can be provided for dealing with the risks identified by this analysis.

### BRIEF DESCRIPTION OF THE DRAWINGS

FIG. 1 is a block diagram of the configuration of a target system to be analyzed by the cloud service threat analysis device according to an embodiment of the present invention;

FIG. 2 is a block diagram of the configuration of the cloud service threat analysis device according to an embodiment of the present invention;

FIG. 3 is a table showing some of the analysis results for the target system produced by the cloud service threat analysis device in FIG. 2,

FIG. 4 is a unique attack method table showing the types of attack methods that may be used, which can be ascertained from the properties of the constituent elements of a DFD;

FIG. 5 is a table showing the association between cloud services and DFD constituent elements;

FIG. 6 is a table showing the scoring criteria for DREAD, which is a risk assessment category;

FIG. 7 is a comparative diagram showing an example of a comparison between a score taken from a score table and a reference score; and

FIG. 8 is a flowchart of the processing flow of the cloud service threat analysis method executed by the cloud service threat analysis device in FIG. 2.

### DETAILED DESCRIPTION OF THE PREFERRED EMBODIMENTS

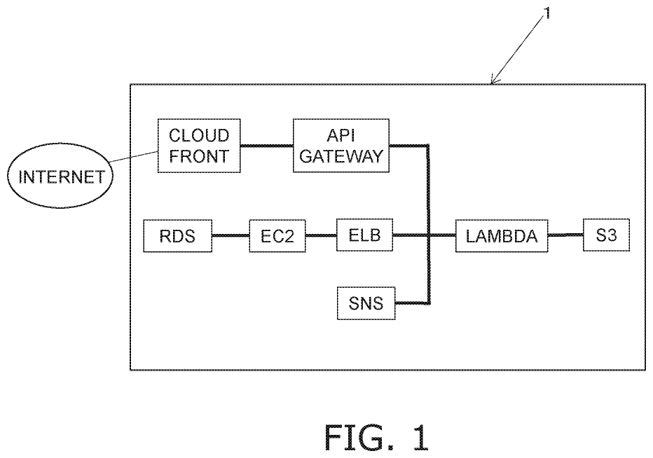

The cloud service threat analysis device according to an embodiment of the present invention will now be described with reference to FIGS. 1 to 8.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

The cloud service threat analysis device 10 according to this embodiment is a device that analyzes security risks that pose a threat to a system that uses cloud services, and is also a device that prompts the user to take action to address these risks. Accordingly, the cloud service threat analysis device 10 is useful for users who are already using a system that uses cloud services, or for users who are planning to build a new system that uses cloud services (hereinafter, “cloud service threat analysis device 10” may be abbreviated as “threat analysis device 10”).

The system to be analyzed by the threat analysis device 10 (hereinafter also referred to as the target system 1) is as shown in FIG. 1, for example. The Cloud Front, API Gateway, RDS, EC2, ELB, Lambda, S3, and SNS that make up the target system 1 are services with well-known functions. Some of these services have multiple resources, and furthermore, if there are multiple resources, some are included in different networks.

The threat analysis device 10 will now be described in detail.

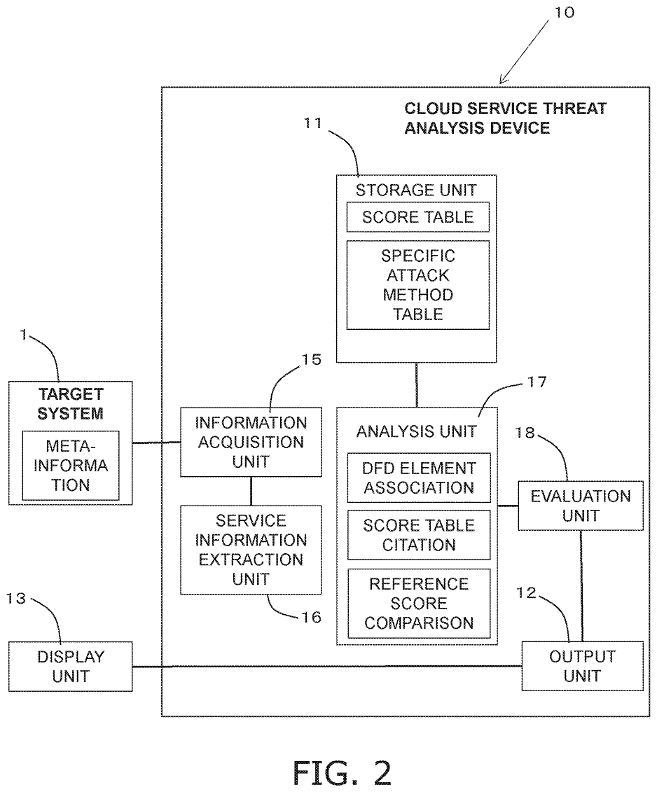

As shown in FIG. 2, the threat analysis device 10 analyzes risks to the target system 1 by performing various types of arithmetic processing on the basis of various programs and data stored in the memory unit 11, and information read from the target system 1. The threat analysis device 10 then outputs the analysis result obtained in the arithmetic processing to the display unit 13 via the output unit 12, and displays the result on the display unit 13.

The various functions of the threat analysis device 10 will now be described in order. As shown in FIG. 2, the threat analysis device 10 includes an information acquisition unit 15, a service information extraction unit 16, an analysis unit 17, and an evaluation unit 18, which are described below.

First, the information acquisition unit 15 acquires information from the target system 1. The information acquisition unit 15 also acquires meta-information had by the analysis target by means of an application programming interface (API).

More specifically, the information acquisition unit 15 acquires information about providers of cloud services used by the target system 1 and the products they offer, for example. That is, the information acquisition unit 15 requests that meta-information about the products be provided, through the provider's API. In response to this request, the provider transmits this meta-information to the threat analysis device 10, and the threat analysis device 10 acquires the transmitted meta-information via the information acquisition unit 15.

Next, the service information extraction unit 16 extracts information related to the services had by the target system 1, on the basis of the information acquired by the information acquisition unit 15. Here, the service information extraction unit 16 extracts information on the basis of the meta-information acquired by the information acquisition unit 15. The service information extraction unit 16 this extracts information, such as the types of service provided by the target system 1, the resources of each service, and the networks that include these resources, on the basis of the meta-information.

At this point, the service information extraction unit 16 acquires the following first and second resource information for the resources of each service along with the extracted information. Specifically, the first resource information is information indicating whether the resources of each service are single or plural, and the second resource information is information indicating whether the resources of each service are included in different networks when there are multiple resources.

Next, the analysis unit 17 analyzes the risks posed to the services included in the target system 1. More specifically, the analysis unit 17 assigns possible attack methods to each service extracted by the service information extraction unit 16, and estimates the risk level of the attack method for the service for each combination of service and attack method.

Here, the types of attack method are determined according to a so-called STRIDE model, which is based on the thoughts and behavior patterns of attackers, and more specifically, these include spoofing, tampering, repudiation, information leakage, denial of service, and privilege elevation. STRIDE is an acronym consisting of the first letters of “Spoofing of user identity,” “Tampering,” “Repudiation,” and “Information disclosure,” “Denial of service,” and “Elevation of privilege.”

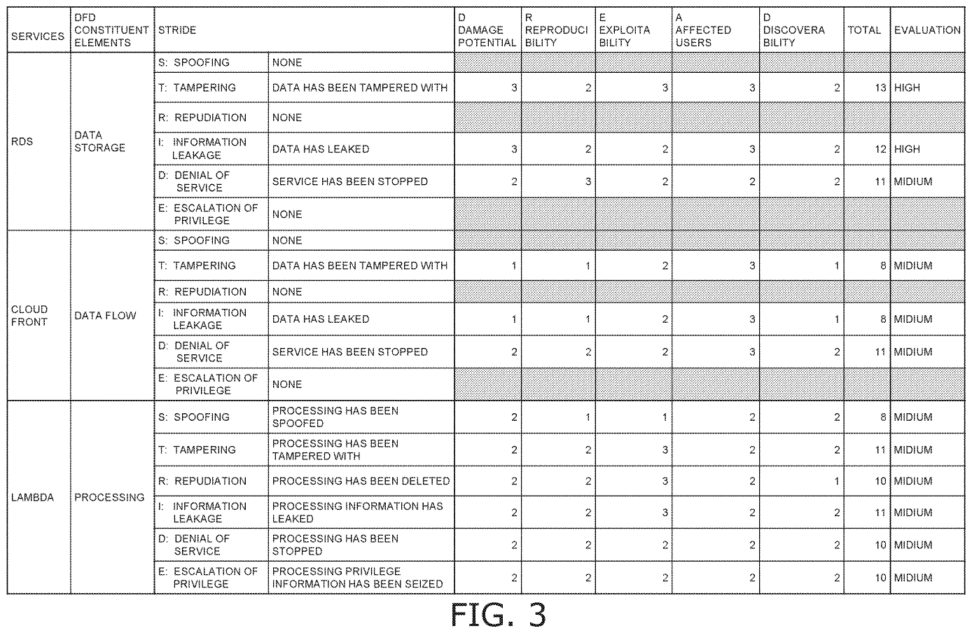

Consequently, the analysis unit 17 estimates the risk level of the attack methods for each service for all of the combinations of individual services included in the target system 1 and the attack methods that may be used against each service. For example, as shown in FIG. 3, for each of the services RDS, Cloud Front, and Lambda, possible attack methods from the six attack methods of the STRIDE model are assigned, and the risk level for each service is found for each of the possible attack methods.

FIG. 3 shows some of the analysis results for the services had by the target system 1, and shows the analysis results for three of the services had by the target system 1, namely, RDS, Cloud Front, and Lambda.

Also, the analysis unit 17 associates services extracted by the service information extraction unit 16 with one of the constituent elements of the data flow diagram (DFD), and when possible an attack method is assigned, assigns an attack method specific to an associated element.

More specifically, the extracted services are associated with one of the four constituent elements of DFD: external entities, processing, data flow, and data storage. For example, RDS is a collection of managed services that allow for simple setup, operate, and scaling of databases in the cloud, and is associated with data storage, among the four constituent elements.

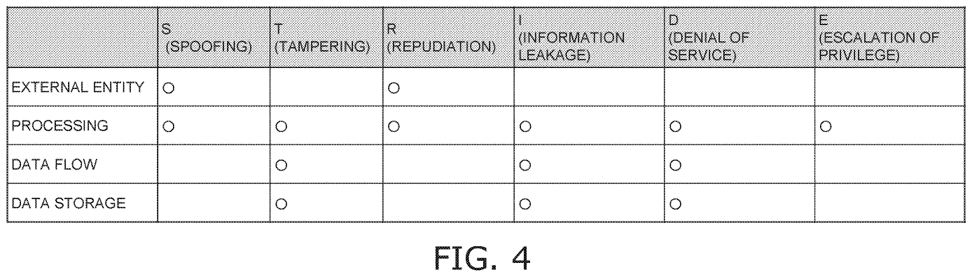

Here, a specific attack method is defined for each element, as shown in FIG. 4. That is, because the types of attack method that may be used can be ascertained for each element from the properties of the constituent elements of the DFD, the types of attack method that can be used against a certain element are defined as attack methods specific to that element.

Then, attack methods other than the specific attack method are excluded from the calculation of the risk level estimate, as they are types of attack methods that are unlikely to be used. A table showing the correlation between the DFD constituent elements and the attack methods specific to each constituent element may hereinafter be referred to as a “specific attack method table.” The specific attack method table is stored in the storage unit 11, as shown in FIG. 2.

For example, among the four constituent elements of DFD, three of the six attack methods in the STRIDE model, namely, spoofing, denial, and escalation of privilege, are unlikely to be used as attack methods against data storage, and are therefore excluded from the attack types specific to data storage. Accordingly, as shown in FIG. 3, in an estimation of the risk level for RDS associated with data storage, the estimation for these three types—spoofing(S), denial (R), and escalation of privilege (E)—are excluded.

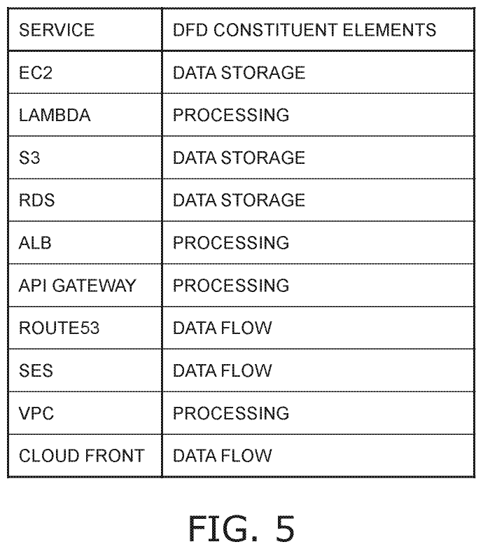

The extracted services and DFD constituent elements are associated as shown in FIG. 5, for example, on the basis of the content of each service and the properties of each constituent element. Also, the function of associating services with DFD constituent elements is sometimes called the “DFD element association function” (see FIG. 2).

Also, the analysis unit 17 estimates the individual risk level by individually weighting each risk assessment category, and estimates the risk level for each combination of service type and attack method type on the basis of the sum of all weighted individual risk levels.

Here, the risk assessment categories are the five so-called DREAD assessment categories, namely, damage potential, reproducibility, exploitability, affected users, and discoverability. DREAD is an acronym for “Damage potential,” “Reproducibility,” “Exploitability,” “Affected users,” and “Discoverability.”

Consequently, the analysis unit 17 handles just the correct number of risk assessment categories and precisely estimates the risk level. For example, as shown in FIG. 3, for each of the RDS, Cloud Front, and Lambda services, the risk level is found for each of the five assessment categories for each possible attack method out of the six attack methods in the STRIDE model. Then, for each of the three services, the risk levels for all five of the assessment categories are tabulated for each possible attack method to estimate the risk level for each combination of service and attack method.

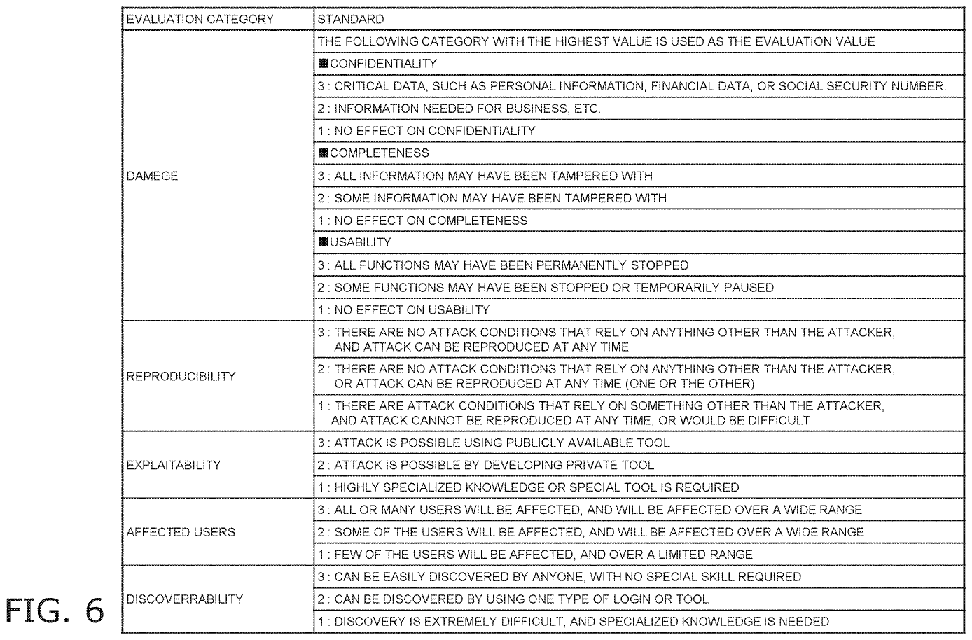

Here, in finding the risk level for each of the five assessment categories, the analysis unit 17 uses a score table, which will be described below. That is, the score table is a data table of scores set for each combination of service type, attack method type, and risk assessment category. Each score is set for each combination of service and attack method, and for each risk assessment category, according to the criteria shown in FIG. 6.

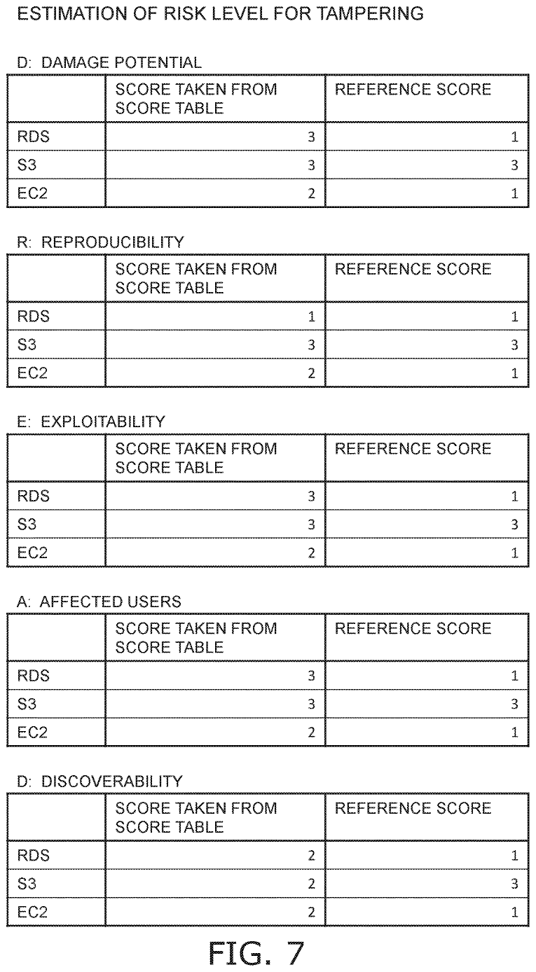

For example, with regard to “Reproducibility,” which is one of the assessment categories, for the tampering of S3, this is considered to correspond to the criterion for “Reproducibility” in FIG. 6, namely, “3: there are no attack conditions that rely on anything other than the attacker, and it is reproducible at any time,” and a score of 3 is set in the score table. Then, as shown in the second table in FIG. 7, the analysis unit 17 estimates the risk level of the “Reproducibility” of the tampering of S3 to be 3, by citing the score of 3 in the score table.

The score table is stored in the storage unit 11, as shown in FIG. 2. The function of estimating the risk level for each combination of service type, attack method type, and risk assessment category by citing the scores in the score table is sometimes called a “score table citation function.”

Furthermore, the analysis unit 17 weights the individual risk levels by referring to the first and second resource information extracted by the service information extraction unit 16. More specifically, the analysis unit 17 sets a reference score that is different from the score in the score table according to the first and second resource information. Then, if a comparison of the score taken from the score table with the reference score reveals the reference score to have a greater weight, the analysis unit 17 replaces the score in the score table with the reference score and estimates the risk level for each combination of service and attack method.

Consequently, the analysis unit 17 sets a reference score that indicates the current state of the service and compares this with the score in the score table, which means that the current state of the service is reflected in a simple manner in the risk level, and a risk level that more closely reflects reality is estimated in a simple manner.

Here, the analysis unit 17 sets the reference score in the following manner, for example. If there is only one resource for a given service in the first resource information, the reference score for that service is set to 1, and if there are a plurality of resources, the reference score for that service is set to 2. Furthermore, if there are a plurality of resources for a given service in the second resource information and they are included in different networks, the reference score for that service is set to 3.

For example, if it is ascertained from the first and second resource information that the number of resources had by RDS, S3, and EC2 of the target system 1 is one, multiple, and one, respectively, and that the multiple resources of S3 are included in different networks, the analysis unit 17 sets the reference scores of RDS, S3, and EC2 to 1, 3, and 1, respectively.

On the other hand, the analysis unit 17 determines from the data in the score table, for example, that the score for the “Discoverability” of tampering with the RDS, is 2. As a result, the analysis unit 17 compares the score of 2 in the score table with the reference score of 1 in relation to the possibility of discovering tampering with the RDS, and determines that the score in the score table has a greater weight. Then, the analysis unit 17 estimates the risk level of the possibility of discovering tampering with the RDS to be 2, without replacing the score value of 2 in the score table with the reference score value of 1 (see the intersection of the row for RDS and T: Tampering and the column for D Discoverability in FIG. 3).

The function of comparing the score taken from the score table with the reference score is sometimes called the “reference score comparison function.”

By tabulating the risk levels for each assessment category thus found, the analysis unit 17 finds the risk level for each attack method for each service (see the column labeled Total in FIG. 3).

Furthermore, the evaluation unit 18 evaluates the required level of defense against attack methods in the service according to the total risk level estimated by the analysis unit 17. More specifically, the required level is evaluated according to the following criteria on the basis of the total for each attack method in each service shown in the Total column in FIG. 3.

That is, if the total risk level is 12 or more, the risk level is viewed as high, and High is displayed, indicating a category that should be protected against. If the total risk level is 8 to 11, the risk level is viewed as medium, and Medium is displayed, indicating a category against which protection is recommended. Furthermore, if the total risk level is 7 or less, the risk level is considered not high, and Low is displayed.

### Threat Analysis Method

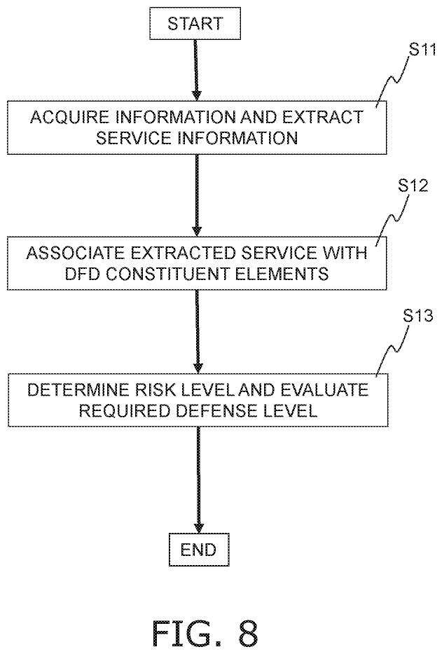

Next, the threat analysis method executed by the threat analysis device 10 will be described with reference to the flowchart shown in FIG. 8.

First, in step S11, information is acquired from the target system 1, and information related to the services with which the target system 1 is equipped is extracted using the acquired information.

In this step, first, the API is used to acquire meta-information had by the target system 1. More specifically, for example, information about the provider of a cloud service used in the target system 1, the products being provided, and so forth is obtained, and a request is made through the provider's API to provide meta-information about the products being provided. This meta-information sent from the provider in response to this request is then acquired.

After this, information related to the services is extracted on the basis of the acquired meta-information. More specifically, the types of service provided by the target system 1, the resources of each service, the networks containing each resource, and other such information is extracted on the basis of the meta-information. Furthermore, the above-mentioned first and second resource information is acquired for the resources of each service.

Then, in step S12, the extracted services are associated with the DFD constituent elements using the above-mentioned DFD element association function, and attack methods of attack with a low probability for each service are excluded from the risk level estimation.

Next, in step S13, the risk level is determined and the required level of defense is evaluated.

In this step, first, the score table reference function is used to set the risk level for all risk assessment categories for each combination of service type and attack method type to the score taken from the score table.

Also, the reference score is set by the above-mentioned reference score comparison function by referring to the first and second resource information acquired in step S11. The score taken from the score table is then compared with the reference score, and if the reference score is greater, the score taken from the score table is replaced with the reference score.

The risk level for each attack method in each service is found by adding up the risk levels for each assessment category thus found. Furthermore, the level of defense required for each attack method in each service is evaluated on the basis of the total risk levels found.

### Main Features

The cloud service threat analysis device 10 of this embodiment includes the information acquisition unit 15, the service information extraction unit 16, the analysis unit 17, and the evaluation unit 18, which will be described below.

First, the information acquisition unit 15 acquires information from the target system 1, using the target system 1 featuring a cloud service as the analysis target. Next, the service information extraction unit 16 extracts information related to the services had by the target system 1 on the basis of the information acquired by the information acquisition unit 15.

The analysis unit 17 assigns possible attack methods to each service extracted by the service information extraction unit 16, and estimates the risk levels of the attack methods for each service for each combination of service and attack method. Furthermore, the evaluation unit 18 evaluates the level of need for defense against the attack method for a service, depending on the risk level estimated by the analysis unit 17.

Consequently, the risk level of attack methods for each service can be estimated for all combinations of the individual services included in the system being analyzed and the attack methods that could be used against each service. This allows risks posing a threat to the system being analyzed to be accurately analyzed. Furthermore, since the level of need to defend against the attack methods used in a service can be evaluated for each combination, it is possible to provide guidelines for dealing with the risks identified by this analysis.

This means that it is possible to comprehensively and accurately analyze risks and evaluate the required level of defense for all of the services that make up the target system 1. As a result, it is possible to accurately analyze risks for the target system 1 that uses cloud services, and then provide guidelines for dealing with the risks identified by this analysis.

### Other Embodiments

An embodiment of the present invention was described above, but the present invention is not limited to or by the above embodiment, and various modifications are possible without departing from the gist of the invention.

### (A)

In the above embodiment, an example was given in which the present invention was realized as the cloud service threat analysis device 10 and a cloud service threat analysis method, but the present invention is not limited to this.

For example, the present invention may be realized as a program that causes a computer to execute the above-mentioned cloud service threat analysis method.

This program is stored in a memory (storage unit 11) installed in the cloud service threat analysis device 10, and the CPU reads the program stored in the memory and causes the hardware to execute the various steps. More specifically, the same effect as above can be obtained if the CPU reads the program and executes the above-mentioned steps S11 to S13.

The present invention may also be realized as a recording medium that stores a program for the cloud service threat analysis device 10.

### (B)

In the above embodiment, spoofing, tampering, repudiation, information leakage, denial of service, and escalation of privilege, which are based on STRIDE, were employed as attack method that pose a threat, but the present invention is not limited to these attack methods, and other attack methods may be used instead.

Also, five assessment categories of DREAD, namely, possibility of damage, reproducibility, exploitability, affected users, and discoverability were employed as the risk assessment categories, but the present invention is not limited to these assessment categories, and other assessment categories may be used instead.

### Addenda

The cloud service threat analysis device according to the first invention comprises:
an information acquisition unit that acquires information from an analysis target, in which the analysis target is a system that uses a cloud service;
a service information extraction unit that extracts information related to services provided by the analysis target, on the basis of the information acquired by the information acquisition unit;
an analysis unit that assigns a possible attack method to each service extracted by the service information extraction unit, and estimates a risk level for that attack method in the service for each combination of the service and the attack method; and
an evaluation unit that evaluates the required level of defense for the service against the attack method for each of the combinations according to the risk level estimated by the analysis unit.

The cloud service threat analysis device according to the second invention is the cloud service threat analysis device according to the first invention,
wherein the analysis unit estimates an individual risk level by individually weighting each risk assessment category, and estimates a risk level for each combination on the basis of the sum of all the weighted individual risk levels.

The cloud service threat analysis device according to the third invention is the cloud service threat analysis device according to the first or second invention,
wherein the types of attack method include spoofing, tampering, repudiation, information leakage, denial of service, and escalation of privilege.

The cloud service threat analysis device according to the fourth invention is the cloud service threat analysis device according to the second invention,
wherein the risk assessment categories include possibility of damage, reproducibility, exploitability, affected users, and discoverability.

The cloud service threat analysis device according to the fifth invention is the cloud service threat analysis device according to the second or fourth invention,
wherein the service information extraction unit extracts first resource information that indicates whether the resource of the service is singular or plural, and second resource information that indicates whether the resource is included in different networks if the resource is plural, and
the analysis unit weights the individual risk levels by referring to the first and second resource information.

The cloud service threat analysis device according to the sixth invention is the cloud service threat analysis device according to any of the first to fifth inventions,
wherein the information acquisition unit acquires meta-information had by the analysis target through an application programming interface (API), and
the service information extraction unit extracts information about services provided by the analysis target, on the basis of the meta-information acquired by the information acquisition unit.

The cloud service threat analysis device according to the seventh invention is the cloud service threat analysis device according to the second, fourth, or fifth invention,
wherein the analysis unit estimates a risk level for each combination of the service and the attack method on the basis of a score table that gives scores set for each combination of the service type, the attack method type, and the risk assessment categories, as data indicating the individual risk level.

The cloud service threat analysis device according to the eighth invention is the cloud service threat analysis device according to the seventh invention,
wherein the service information extraction unit extracts first resource information that indicates whether the resource of the service is singular or plural, and second resource information that indicates whether the resource is included in different networks if the resource is plural, and
the analysis unit sets a reference score different from the score in the score table according to the first and second resource information, and if a comparison of the score in the score table with the reference score reveals that the reference score is more heavily weighted, the score in the score table is replaced with the reference score, and a risk level is estimated for each combination of the service and the attack method.

The cloud service threat analysis device according to the ninth invention is the cloud service threat analysis device according to any of the first to eighth inventions,
wherein the analysis unit associates each of the services extracted by the service information extraction unit with one of the constituent elements of a data flow diagram (DFD), and when assigning a possible attack method, assigns an attack method specific to the associated element.

### EXPLANATION OF REFERENCE

1 target system
10 cloud service threat analysis device
11 storage unit
12 output unit
13 display unit
15 information acquisition unit
16 service information extraction unit
17 analysis unit
18 evaluation unit

What is claimed is:

1. A cloud service threat analysis device, comprising:
an information acquisition unit that acquires information from an analysis target, in which the analysis target is a system that uses a cloud service;
a service information extraction unit that extracts information related to services provided by the analysis target, on the basis of the information acquired by the information acquisition unit;
an analysis unit that assigns a possible attack method to each service extracted by the service information extraction unit, and estimates a risk level for that attack method in the service for each combination of the service and the attack method; and
an evaluation unit that evaluates the required level of defense for the service against the attack method for each of the combinations according to the risk level estimated by the analysis unit.

2. The cloud service threat analysis device according to claim 1,
wherein the analysis unit estimates an individual risk level by individually weighting each risk assessment category, and estimates a risk level for each combination on the basis of the sum of all the weighted individual risk levels.

3. The cloud service threat analysis device according to claim 1,
wherein the types of attack method include spoofing, tampering, repudiation, information leakage, denial of service, and escalation of privilege.

4. The cloud service threat analysis device according to claim 2,
wherein the risk assessment categories include possibility of damage, reproducibility, exploitability, affected users, and discoverability.

5. The cloud service threat analysis device according to claim 2,
wherein the service information extraction unit extracts first resource information that indicates whether the resource of the service is singular or plural, and second resource information that indicates whether the resource is included in different networks if the resource is plural, and
the analysis unit weights the individual risk levels by referring to the first and second resource information.

6. The cloud service threat analysis device according to claim 1,
wherein the information acquisition unit acquires meta-information had by the analysis target through an application programming interface (API), and
the service information extraction unit extracts information about services provided by the analysis target, on the basis of the meta-information acquired by the information acquisition unit.

7. The cloud service threat analysis device according to claim 2,
wherein the analysis unit estimates a risk level for each combination of the service and the attack method on the basis of a score table that gives scores set for each combination of the service type, the attack method type, and the risk assessment categories, as data indicating the individual risk level.

8. The cloud service threat analysis device according to claim 7,
wherein the service information extraction unit extracts first resource information that indicates whether the resource of the service is singular or plural, and second resource information that indicates whether the resource is included in different networks if the resource is plural, and
the analysis unit sets a reference score different from the score in the score table according to the first and second resource information, and if a comparison of the score in the score table with the reference score reveals that the reference score is more heavily weighted, the score in the score table is replaced with the reference score, and a risk level is estimated for each combination of the service and the attack method.

9. The cloud service threat analysis device according to claim 1,
wherein the analysis unit associates each of the services extracted by the service information extraction unit with one of the constituent elements of a data flow diagram (DFD), and when assigning a possible attack method, assigns an attack method specific to the associated element.

10. A cloud service threat analysis method, comprising:
an information acquisition step of acquiring information from an analysis target, in which the analysis target is a system that uses a cloud service;
a service information extraction step of extracting information related to services provided by the analysis target on the basis of the information acquired by the information acquisition step;
an analysis step of assigning a possible attack method to each service extracted by the service information extraction step, and estimating a risk level of the attack method in the service for each combination of the service and the attack method; and
an evaluation step of evaluating the required level of defense for the service against the attack method, according to the risk level estimated by the analysis unit.

11. A cloud service threat analysis program that causes a computer to execute a cloud service threat analysis method comprising:
an information acquisition step of acquiring information from an analysis target, in which the analysis target is a system that uses a cloud service;
a service information extraction step of extracting information related to services provided by the analysis target on the basis of the information acquired by the information acquisition step;
an analysis step of assigning a possible attack method to each service extracted by the service information extraction step, and estimating a risk level of the attack method in the service for each combination of the service and the attack method; and
an evaluation step of evaluating the required level of defense for the service against the attack method, according to the risk level estimated by the analysis unit.
